(19) United States
(12) Patent Application Publication
(10) Pub. No.: US 2014/0362467 A1
(43) Pub. Date: Dec. 11, 2014

(54) HEAD SUSPENSION ASSEMBLY AND DISK DEVICE WITH THE ASSEMBLY

(71) Applicant: Kabushiki Kaisha Toshiba, Tokyo (JP)

(72) Inventors: Yusuke Nojima, Yokohama-shi (JP); Yasutaka Sasaki, Yokohama-shi (JP)

(73) Assignee: KABUSHIKI KAISHA TOSHIBA, Tokyo (JP)

(21) Appl. No.: 14/022,027

(22) Filed: Sep. 9, 2013

(30) Foreign Application Priority Data
Jun. 6, 2013 (JP) 2013-119723

(51) Int. Cl. G11B 33/14; G11B 5/48

(52) U.S. Cl. CPC G11B 33/14; G11B 5/4873
USPC 360/97.13; 360/294.4

(57) ABSTRACT

According to one embodiment, a head suspension assembly includes a base plate, a load beam including a proximal end secured onto the base plate, a head supported on the load beam via a gimbal, a flexure attached on the load beam and the base plate, and first and second piezoelectric elements in first and second openings of the base plate. The proximal end of the load beam includes first and second extended connections bifurcated from the proximal end and connected to the base plate, first and second island connections, and an opening region exposing the base plate. The flexure extends between the first and second extended connections and between the first and second island connections, and is directly provided on the base plate.

### CROSS-REFERENCE TO RELATED APPLICATIONS

This application is based upon and claims the benefit of priority from Japanese Patent Application No. 2013-119723, filed Jun. 6, 2013, the entire contents of which are incorporated herein by reference.

### FIELD

Embodiments described herein relate generally to a head suspension assembly for use in a disk device, and a disk device with the assembly.

### BACKGROUND

Recently, disk devices, such as magnetic disk devices and optical disk devices, have been widely used as external recording devices or image recording devices for computers.

A magnetic disk device as an example of a disk device generally comprises a magnetic disk contained in a housing, a spindle motor supporting and configured to rotate the magnetic disk, and a head suspension assembly supporting a magnetic head. The head suspension assembly comprises a suspension attached to the distal end of an arm, the magnetic head supported by the suspension, and a flexure (wiring trace) provided on the suspension and outwardly extended therefrom. The wiring of the flexure is electrically connected to the magnetic head. Further, the suspension includes a load beam, and a base plate secured to the proximal end of the load beam and to the distal end of the arm.

Head suspension assemblies of a dual stage actuator (DSA) type have recently been available in which one or more piezoelectric elements are provided on a base plate. When a voltage is applied to a piezoelectric element, this element operates to swing the load beam connected to the base plate to thereby move the magnetic head attached to the load beam. Namely, by controlling the voltage applied to the piezoelectric element, the operation of the magnetic head is controlled.

In the head suspension assembly constructed as the above, one end of the load beam is attached on the base plate, and the flexure is attached on the load beam. Therefore, the maximum thickness of the base plate region of the suspension is the sum of the thickness of the base plate, that of the load beam and that of the flexure. This structure inevitably increases the suspension maximum thickness of the base plate region, thereby narrowing the clearance between the suspension and a recording medium (magnetic disk). With this structure, when the magnetic disk device receives some impact during operation, the possibility of the suspension being brought into contact with the recording medium is strong. This means that the magnetic disk device has a weak resistance against impact. In addition, since the distance between the flexure and the magnetic disk is short, a high wind vibration force is applied to the flexure while the magnetic disk is rotating, which means that the flexure has a low resistance against wind disturbance.

### BRIEF DESCRIPTION OF THE DRAWINGS

FIG. 1 is an exemplary perspective view illustrating a hard disk drive (HDD) according to a first embodiment, with its top cover removed;

FIG. 2 is an exemplary perspective view illustrating a head suspension assembly incorporated in the HDD;

FIG. 3 is an exemplary perspective view illustrating a portion of the head suspension assembly on a magnetic head side;

FIG. 4 is an exemplary exploded perspective view illustrating the head suspension assembly;

FIG. 5 is an exemplary plan view illustrating a connection of the head suspension assembly;

FIG. 6 is an exemplary cross-sectional view taken along line ABC of FIG. 5, illustrating the head suspension assembly;

FIG. 7A is a graph illustrating a relationship between gaps of a head suspension and a magnetic disk and contact start impact values;

FIG. 7B is a schematic side view showing the relationship between the head suspension and the magnetic disk;

FIG. 8 is an exemplary plan view illustrating a connection of a head suspension assembly incorporated in an HDD according to a second embodiment;

FIG. 9 is an exemplary plan view illustrating a connection of a head suspension assembly incorporated in an HDD according to a third embodiment;

FIG. 10 is an exemplary cross-sectional view taken along line ABC of FIG. 9, illustrating the head suspension assembly;

FIG. 11 is an exemplary plan view illustrating a connection of a head suspension assembly incorporated in an HDD according to a fourth embodiment; and

FIG. 12 is an exemplary cross-sectional view taken along line ABC of FIG. 11, illustrating the head suspension assembly.

### DETAILED DESCRIPTION

Various embodiments will be described hereinafter with reference to the accompanying drawings. In general, according to one embodiment, a head suspension assembly comprises: a base plate including a first opening and a second opening; a load beam including a proximal end secured onto the base plate and extending from the base plate; a head supported on the load beam; a flexure comprising a plurality of lines electrically connected to the head, and attached on the load beam and the base plate; and a first piezoelectric element in the first opening of the base plate, and a second piezoelectric element in the second opening of the base plate. The proximal end of the load beam comprises first and second extended connections bifurcated from the proximal end and connected to the base plate, first and second island connections separate from each other and from the first and second extended connections and connected to the base plate, and an opening region exposing the base plate; the first piezoelectric element comprises an end connected to the first extended connection, and another end connected to the first island connection; the second piezoelectric element comprises an end connected to the second extended connection, and another end connected to the second island connection; and the flexure extends, in the proximal portion of the load beam, between the first and second extended connections and between the first and second island connections, and directly provided on the base plate.

Hard disk drives (HDDs) as magnetic disk devices according to embodiments will be hereinafter described in detail.

### First Embodiment

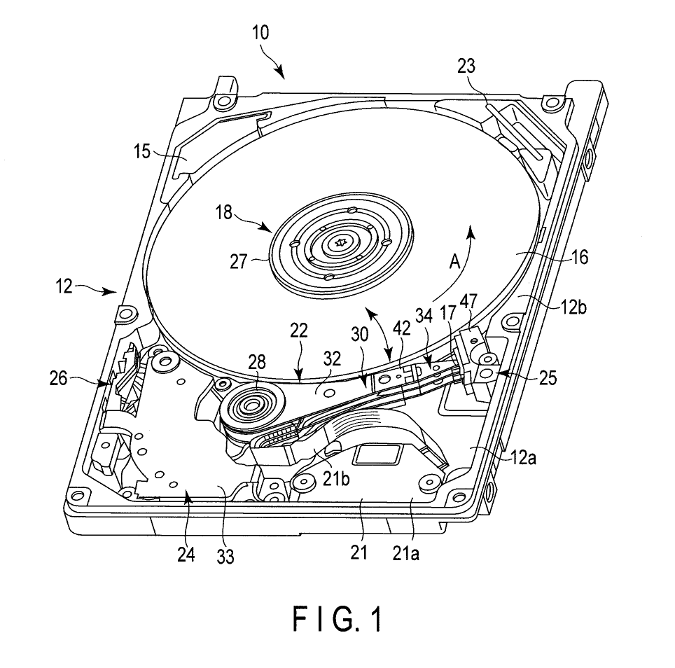

FIG. 1 shows the internal configuration of an HDD assumed when its top cover is removed. As shown in FIG. 1, the HDD comprises a housing 10. The housing 10 comprises an open-topped rectangular box-shaped base 12, and a non-illustrated top cover secured to the base 12 with a plurality of screws to close the upper end opening of the base 12. The base 12 includes a rectangular bottom wall 12a and sidewalls 12b extending upright along the periphery of the bottom wall 12a.

The housing 10 contains two magnetic disks 16 as recording media, and a spindle motor 18 as a driving section which supports and rotates the magnetic disks 16. The spindle motor 18 is provided on the bottom wall 12a. Each magnetic disk 16 has a diameter of, for example, 65 mm (2.5 inches), and comprises magnetic recording layers on upper and lower surfaces thereof. Each magnetic disk 16 is engaged coaxially with a non-illustrated hub incorporated in the spindle motor 18, and is secured to the hub by a clamp spring 27. In this manner, each magnetic disk 16 is supported and positioned parallel to the bottom wall 12a of the base 12. The magnetic disks 16 are rotated at a predetermined speed by the spindle motor 18.

The housing 10 also contains plural magnetic heads 17 that record and read information onto and from the magnetic disks 16, and a head stack assembly 22 that supports the magnetic heads 17 to be movable relative to the magnetic disks 16. The housing 10 further contains a voice coil motor (VCM) 24, a ramp load mechanism 25, a latch mechanism 26 and a board unit 21. The VCM 24 rotates and positions the head stack assembly 22. The ramp load mechanism 25 holds the magnetic heads 17 at an unloaded position apart from the magnetic disks 16 when the magnetic heads 17 are moved to outermost periphery of the magnetic disks 16. The latch mechanism 26 holds the head stack assembly 22 in a retracted position when the HDD receives some impact. The board unit 21 is provided with electronic components, such as a conversion connector. The latch mechanism 26 is not limited to a mechanical unit, but may be a magnetic one.

A non-illustrated printed circuit board is screwed to the outer surface of the bottom wall 12a of the base 12. The printed circuit board controls the spindle motor 18, VCM 24, and magnetic heads 17 through the board unit 21. A circulation filter 23 that traps dust produced in the housing when the movable element is moved is provided in the housing outside the magnetic disks 16. A breather filter 15 that traps dust from the air flowing into the housing 10 is provided in the housing 10 near one sidewall 12b of the base 12.

As shown in FIG. 1, the head stack assembly 22 comprises a rotatable bearing unit 28, and four head suspension assemblies 30, and non-illustrated spacer rings. The four head suspension assemblies are attached to the bearing unit 28, stacked on each other. Each spacer ring is stacked between a corresponding pair of the head suspension assemblies 30.

The bearing unit 28 comprises a pivot shaft and a circular cylindrical sleeve. The pivot shaft stands on the bottom wall 12a of the base 12 near the outer peripheral edges of the magnetic disks 16. The circular cylindrical sleeve is rotatably supported by the pivot shaft via a bearing.

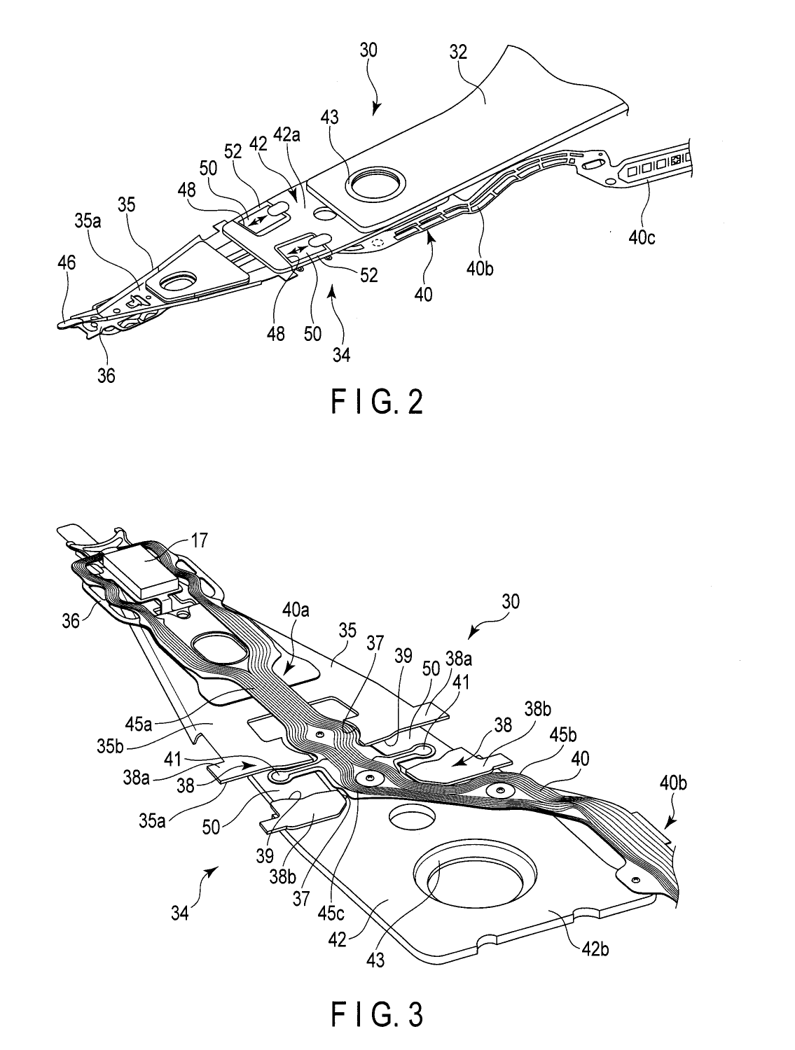

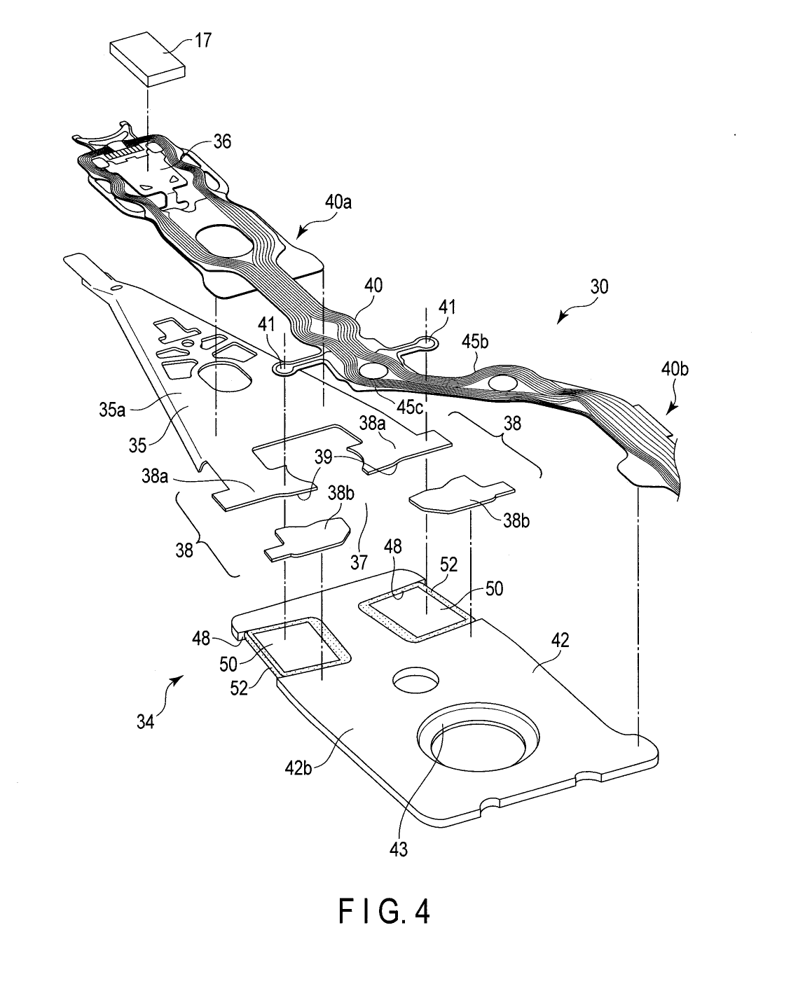

FIG. 2 is a perspective view showing one of the head suspension assemblies 30. FIG. 3 is a perspective view illustrating the magnetic head side portion of the one head suspension assembly 30. FIG. 4 is an exploded perspective view of the suspension assembly 30. As shown in FIGS. 1 to 4, each head suspension assembly 30 comprises an arm 32, a suspension 34, and a magnetic head 17. The arm 32 extends from the bearing unit 28. The suspension 34 extends from the arm 32. The magnetic head 17 is supported at the extending end of the suspension 34. Although in the first embodiment, the head suspension assembly 30 includes the arm 32, the invention is not limited to this. The head suspension assembly 30 may not include the arm.

The arm 32 is formed of, for example, stainless steel or aluminum in the shape of an elongated flat plate. The arm 32 comprises a distal end on the extending end side. At the distal end, a swaging seat surface with a non-illustrated swaging hole is formed. The suspension 34 comprises a load beam 35, a gimbal 36, and a substantially rectangular base plate 42. The load beam 35 is of an elongate plate-spring type. The gimbal 36 is attached to the extending end of the load beam 35. The base plate 42 is secured to and layered on the proximal end of the load beam 35. Further, the load beam 35 extends from the base plate 42 and is tapered toward its extending end. Each magnetic head 17 is secured to the gimbal 36 and supported by the load beam 35 via the gimbal 36. The base plate 42 and the load beam 35 are formed of, for example, stainless steel. The base plate 42 has a thickness of, for example, 150 μm and the load beam 35 has a thickness of, for example, 25-30 μm.

The base plate 42 has a first surface 42a and a second surface 42b opposite to the first surface. The base plate 42 comprises a circular opening formed in the proximal end thereof, and an annular protruding part 43 protruding from the first surface 42a around the periphery of the opening. The base plate 42 is fastened to the distal end of the arm 32 by superposing the first surface 42a side portion of the proximal end of the plate 42 upon the swaging seat surface of the distal end of the arm 32, engaging a non-illustrated opening of the arm 32 with circular projection of the base plate 42, and swaging the protruding part 43.

As shown in FIGS. 2 to 4, the load beam 35 includes a first surface 35a and a second surface 35b opposite to the first surface. The proximal end of the load beam 35 is secured to the base plate 42 by superposing the first surface 35a side portion of the proximal end of the beam 35 upon the second surface 42b side portion of the distal end of the base plate 42, and welding the same at several points. The width of the proximal end of the load beam 35 is formed substantially equal to the width of the base plate 42.

As shown in FIGS. 2 to 5, a pair of openings 48 (first and second openings) that function as mount holes are formed in the opposite sides of the load beam 35 side end of the base plate 42. The openings 48 each open at the opposite surfaces of the base plate 42 and at one side edge thereof. The openings 48 are provided along the width of the base plate 42 with a gap therebetween. In the openings 48, piezoelectric elements (first and second piezoelectric elements) 50 which function as piezoelectric materials 50 are located and fixed in the respective openings 48 by an adhesive 58. The piezoelectric elements 50 are formed in, for example, a rectangular plate shape, and are arranged substantially parallel with the surface of the base plate 42.

The proximal end of the load beam 35 includes an elongated opening region 37 formed in the widthwise central portion of the beam, a pair of extended connections (first and second extended connections) 38a positioned at the opposite sides of the opening region 37 and extending laterally, and a pair of completely isolated island connections (first and second island connections) 38b. The opening region 37 extends up to the proximal end of the load beam 35 to expose therein the second surface 42b of the base plate 42. The extended connections 38a and the island connections 38b are connected to the base plate 42 on the second surface 42b of the plate 42. An opening 39 is formed between the extended connections 38a and the island connections 38b to have a size smaller than the piezoelectric elements 50. The extended connections 38a and the island connections 38b are secured to the base plate 42 with the opening 39 opposed to the piezoelectric elements 50. The extended connections 38a and the island connections 38b overlap with the longitudinal opposite ends of the piezoelectric elements 50, and are connected to the piezoelectric elements 50 by, for example, an adhesive.

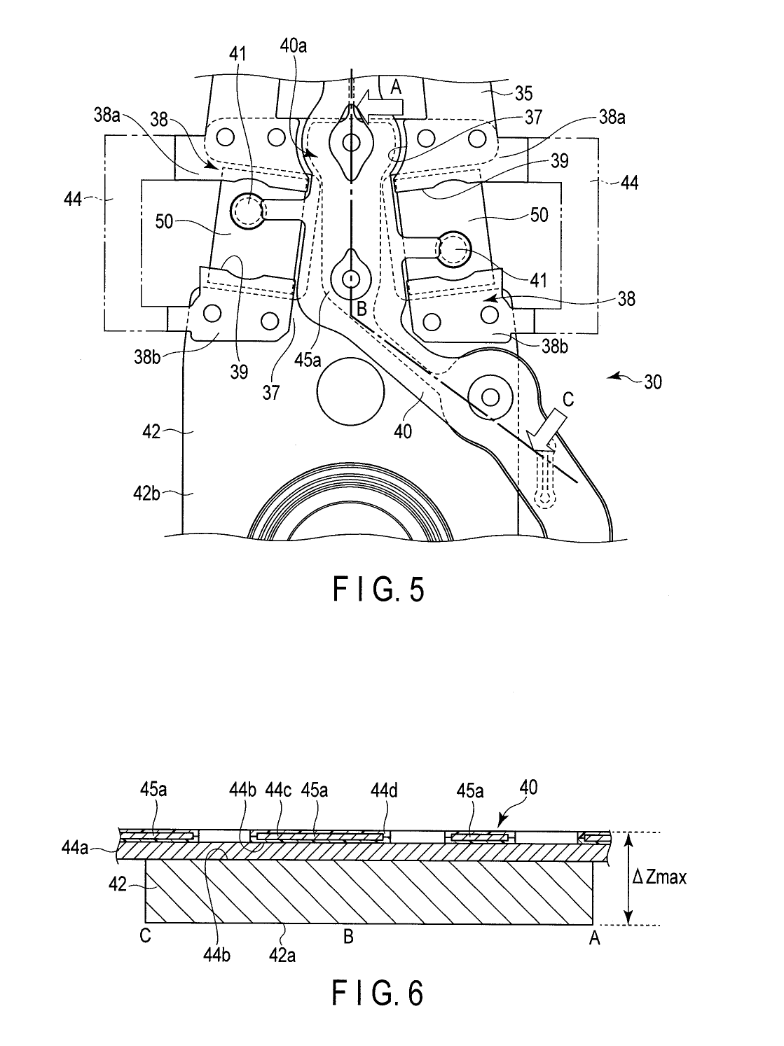

In the manufacturing process of the head suspension assemblies 30, before the load beam 35 is connected to the base plate 42, the island connections 38b and the extended connections 38a are coupled to each other by a U-shaped reinforcing bridge 44 as shown in FIG. 5, in order to enable the load beam 35 to be treated as one component, and to secure the strength of the island connections 38b. After connecting the load beam 35 to the base plate 42, the reinforcing bridge 44 may be cut off.

In the above structure in which the proximal end of the load beam 35 is connected to the piezoelectric elements 50, when a voltage is applied to each piezoelectric element 50, each piezoelectric element 50 expands and contracts along the length of the suspension 34, as indicated by the arrows in FIG. 2. Each magnetic head 17 can be displaced by selectively driving the two piezoelectric elements 50 so as to swing the load beam 34a.

As shown in FIGS. 2 to 5, each head suspension assembly 30 has a strip-shaped flexure (wiring trace) 40. The flexure 40 has its front portion 40a provided on the gimbal 36, the load beam 35 and the base plate 42, and its rear portion (extended portion) 40b outwardly extending from a side of the base plate 42 along a side of the arm 32.

FIG. 6 is a cross-sectional view taken along line ABC of FIG. 5, illustrating the head suspension assembly 30. As shown in FIGS. 2 to 6, the flexure 40 comprises a thin metal plate (liner layer) 44a, an insulating layer 44b formed on the metal thin plate, a conductive layer (wiring pattern) 44c, and a protection layer (insulating layer) 44d, thereby forming a layered plate of an elongate band type. The thin metal plate 44a is made of stainless steel to form a base. The conductive layer 44c is formed on the insulating layer and provides plural lines 45a. The flexure 40 has its thin metal plate 44a side bonded or pivot-welded on the second surface 35b of the load beam 35 and on the second surface of the base plate 42. The end of the thin metal plate 44a on the load beam 35 side is formed to also serve as the gimbal 36.

Further, the front portion 40a of the flexure 40 extends from the magnetic head 17 to the proximal end of the load beam 35 through the central portion of the load beam 35, further extends over the second surface 42b of the base plate 42, and outwardly extends from a side edge of the base plate 42. Furthermore, as shown in FIGS. 3 to 6, in the region in which the proximal end of the load beam 35 overlaps with the base plate 42, the flexure 40 is provided within the opening region 37 of the load beam 35 such that it directly touches the second surface 42b of the base plate 42.

As shown in FIG. 2, the extended portion 40b of the flexure 40 outwardly extends from the side edge of the base plate 42 along the arm 32 up to a position near the bearing unit 28. A connection end 40c incorporated in the flexure 40 as the rear end of the extended portion 40b is connected to a main FPC 21b, described later.

As shown in FIGS. 3 to 6, the conductive layer 44c of the flexure 40 provides the plural lines 45a arranged along the width of the flexure. The lines 45a extend along the entire length of the flexure 40, and each have one end electrically connected to the corresponding magnetic head 17 and the other end connected to a connection terminal (connection pad) incorporated in the connection end 40c. Thus, the magnetic heads 17 are electrically connected to the main FPC 21b and the board unit 21 via the lines 45a of the flexure 40.

The conductive layer 44c of the flexure 40 comprises two conductive lines 45b and 45c and two drive pads 41. The two conductive lines 45b and 45c are positioned on the widthwise opposite sides of the flexure 40, with the lines 45a interposed therebetween. The two drive pads 41 horizontally extend from ends of the two lines 45b and 45c, and are electrically connected to the respective piezoelectric elements 50.

On the other hand, as shown in FIG. 1, the head stack assembly 22 comprises a support frame that extends from the bearing unit 28 away from the arms 32. A voice coil forming part of the VCM 24 is embedded in the support frame. When the head stack assembly 22 constructed as the above is assembled on the base 12, the lower end of the pivot shaft of the bearing unit 28 is secured to the base 12 such that the bearing 28 stands substantially parallel to the spindle of the spindle motor 18. Each magnetic disk 16 is positioned between the corresponding pair of the head suspension assemblies 30. When the HDD operates, the magnetic heads 17 attached to the suspensions 34 oppose the upper and lower surfaces of the magnetic disks 16. The voice coil secured to the support frame is positioned between a pair of yokes 33 secured to the base 12. The voice coil, along with the yokes and a non-illustrated magnet secured to one or two of the yokes, constitutes the VCM 24.

As shown in FIG. 1, the board unit 21 comprises a main body 21a formed of a flexible printed circuit board. The body 21a is secured to the bottom wall 12a of the base 12. Electronic components, such as a head amplifier, are mounted on the body 21a. A non-illustrated connector to connect with the printed circuit board is mounted on a bottom surface of the body 21a.

The board unit 21 comprises a main flexible printed circuit board (main FPC) 21b extended from the body 21a. The extending end of the main FPC 21b constitutes a connection, and is secured in the vicinity of the bearing unit 28 of the head stack assembly 22. The flexure 40 of each head suspension assembly 30 is mechanically and electrically connected to the connection of the main FPC 21b. In this manner, the board unit 21 is electrically connected to the magnetic heads 17 and piezoelectric elements 50 through the main FPC 21b and flexures 40.

As shown in FIG. 1, the ramp load mechanism 25 comprises a ramp 47 and tabs 46. The ramp 47 is provided outside the magnetic disks 16 on the bottom wall 12a of the base 12. The tabs 46 (see FIGS. 2 and 3) are extended from the distal ends of the suspensions 34, respectively. When the head stack assembly 22 pivots about the bearing unit 28 and the magnetic heads 17 move to a retracted position outside the magnetic disks 16, the tabs 46 are each engaged with a ramp surface formed on the ramp 45 and is then pulled up along the inclination of the ramp surface. Thus, the magnetic heads 17 are unloaded from the magnetic disks 16 and are held at the retracted position.

In the HDD and head suspension assemblies 30 constructed as the above, the piezoelectric elements 50 are provided on each base plate 42. Each load beam 35 connected to the corresponding base plate 42 can be operated to swing by applying a voltage to the piezoelectric elements 50 through the flexure 40. As a result, the magnetic heads 17 attached to the load beams 35 can be displaced. Thus, the positions of the magnetic heads 17 attached to the load beams 35 can be finely controlled by controlling the voltage applied to the piezoelectric elements 50, thereby enhancing the accuracy of positioning the magnetic heads. Further, in the region in which the proximal end of the load beam 35 of each head suspension assembly 30 overlaps with the corresponding base plate 42, the flexure 40 is provided within the opening region 37 formed in the load beam 35, and is directly stacked on and connected to the surface of the base plate 42 without overlapping with the load beam 35. Accordingly, as shown in FIG. 6, the maximum thickness ΔZmax of the base plate 42 zone of each head suspension assembly 30 is the sum of the thickness of the base plate 42 and the thickness of the flexure 40. Namely, the maximum thickness ΔZmax does not include the thickness of the load beam 35, which means that the head suspension assembly 30 can be made thinner by the thickness of the load beam 35.

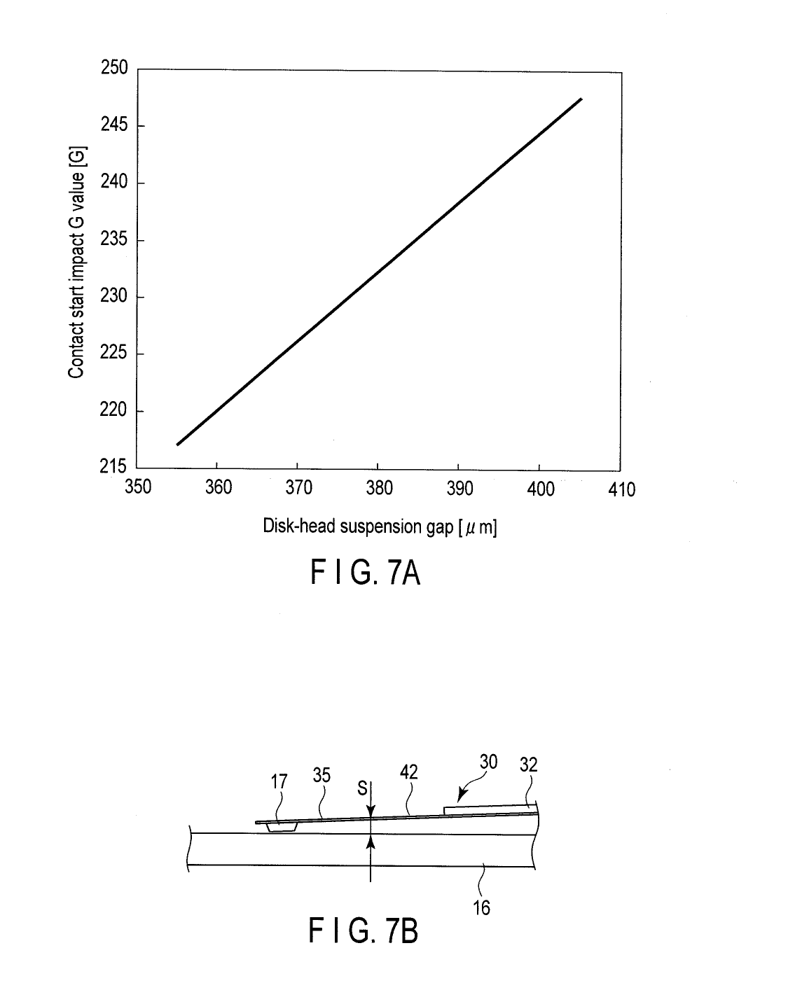

FIG. 7A is a graph illustrating the relationship between the gap S between a magnetic disk and a head suspension assembly 30 (e.g., the gap between the portion of the head suspension assembly, on which piezoelectric elements are located, and the surface of the magnetic disk 16) and the contact start impact G value. FIG. 7B is a schematic side view showing the relationship between the head suspension and the magnetic disk. From FIGS. 7A and 7B, it can be understood that the contact start impact G value increases in accordance with an increase in the gap S. Namely, in accordance with an increase in the gap S, the possibility of the head suspension assembly 30 being brought into contact with the magnetic disk when the HDD receives impact decreases, thereby enhancing the resistance of the HDD against the impact. Since in the above-described first embodiment, the head suspension assembly 30 is thinned to increase the gap S, the resistance of the HDD against impact is enhanced.

Further, since the distance between the flexure and the magnetic disk is increased, the wind vibration force exerted on the flexure when the magnetic disk rotates can be suppressed, thereby enhancing the resistance against wind disturbance.

As described above, the first embodiment can provide a head suspension assembly of enhanced resistance against impact and wind disturbance, and a disk device including the head suspension assembly.

The following is a description of head suspension assemblies in HDDs according to alternative embodiments. In the description of these alternative embodiments to follow, like reference numbers are used to designate the same parts as those of the first embodiment, and a detailed description thereof is omitted. Different parts will be mainly described in detail.

### Second Embodiment

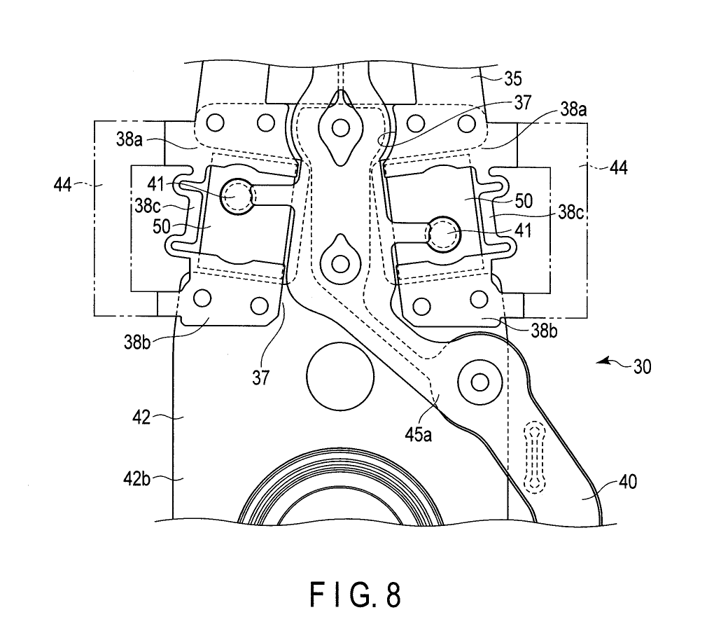

FIG. 8 is a plan view illustrating the connection of a head suspension assembly incorporated in an HDD according to a second embodiment. In the second embodiment, the island connections 38b and the extended connections 38a of the load beam 35 are coupled by elongated coupling portions 38c with elasticity. This structure can provide the same advantage as that of the above described first embodiment.

Further, in the second embodiment, in the process of manufacturing the head suspension assembly 30, the end portions of the island connections 38b and the extended connections 38a are coupled by a U-shaped reinforcing bridge 44 before connecting the load beam 35 to the base plate 42, in order to secure the strength of the island connections 38b. After connecting the load beam 35 to the base plate 42, the reinforcing bridge 44 may be cut off.

### Third Embodiment

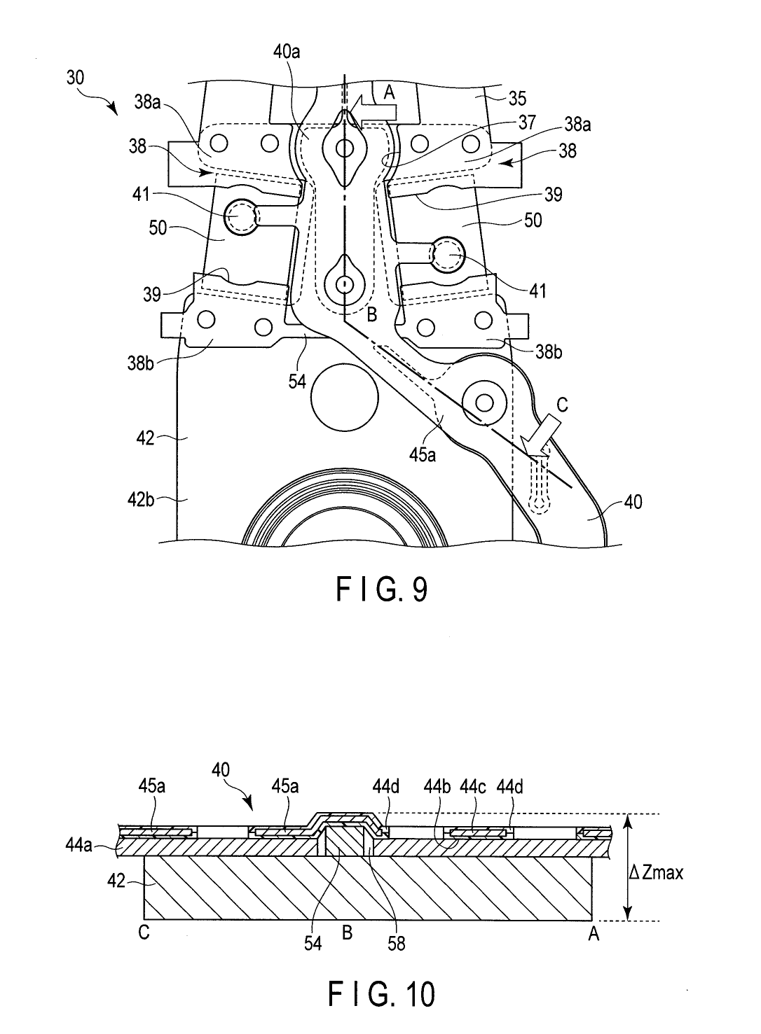

FIG. 9 is a plan view illustrating the connection of a head suspension assembly incorporated in an HDD according to a third embodiment, and FIG. 10 is a cross-sectional view taken along line ABC of FIG. 9, illustrating the head suspension assembly. In the third embodiment, the load beam 35 comprises, at a connection area (proximal end) 38, a bridge portion 54 formed by connecting two island connections 38b. The bride portion 54 extends along the width of the load beam through the opening region 37 of the proximal end of the load beam 35.

In the flexure 40 positioned in the opening region 37 of the load beam 35, the region of the metal thin plate 44a overlapping with the bridge portion 54 is cut off to form a receiving slit 58. The flexure 40 is directly coupled to the surface of the base plate 42 with the bridge portion 54 received in the receiving slit 58. In the receiving slit 58, only the insulating layer 44b, the conductive layer 44c and the protection layer 44d of the flexure 40 are stacked on the bridge portion 54.

In the head suspension assembly 30 constructed as the above, the mechanical strength of the connection area 38 of the load beam 35 is enhanced by coupling the island connections 38b of the connection area 38 by the bridge portion 54. Further, since in the region in which the flexure 40 and the bridge portion 54 overlap, the metal thin plate 44a of the flexure is cut off, the maximum thickness ΔZmax of the base plate 42 region is the sum of the thickness of the base plate 42, thickness of the load beam 35 and the thicknesses of the insulating layer/conductive layer/protection layer of the flexure 40. Namely, the maximum thickness ΔZmax does not include the thickness of the metal thin plate 44a of the flexure 40, which means that the head suspension assembly 30 can be made thinner by the thickness of the metal thin plate 44a. As a result, a head suspension assembly with enhanced resistance against impact and wind disturbance can be obtained.

Also in the third embodiment, the island connections 38b and the extended connections 38a of the load beam 35 may be coupled using elongated coupling portions 38c with elasticity, as in the second embodiment.

### Fourth Embodiment

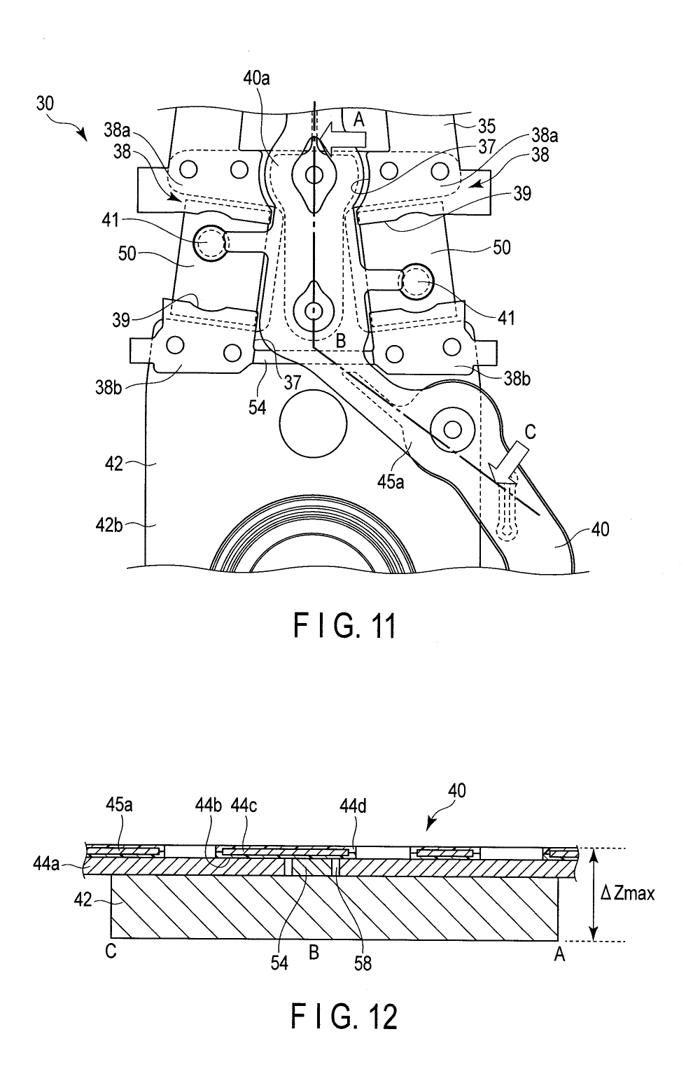

FIG. 11 is a plan view illustrating the connection of a head suspension assembly incorporated in an HDD according to a fourth embodiment, and FIG. 12 is a cross-sectional view taken along line ABC of FIG. 11, illustrating the head suspension assembly. In the fourth embodiment, the load beam 35 comprises, at a connection area (proximal end) 38, a bridge portion 54 formed by connecting two island connections 38b, as in the third embodiment. The bride portion 54 extends along the width of the load beam 35 through the opening region 37 of the proximal end of the load beam 35. Further, in the fourth embodiment, the bride portion 54 is thinned by, for example, half etching to substantially the same thickness as the metal thin plate 44a of the flexure 40.

In the flexure 40 positioned in the opening region 37 of the load beam 35, the region of the metal thin plate 44a overlapping with the bridge portion 54 is cut off to form a receiving slit 58. The flexure 40 is directly coupled to the surface of the base plate 42 with the bridge portion 54 received in the receiving slit 58. In the receiving slit 58, only the insulating layer 44b, the conductive layer 44c and the protection layer 44d of the flexure 40 are stacked on the bridge portion 54.

In the head suspension assembly 30 constructed as the above, since the bridge portion 54 has substantially the same thickness as the metal thin plate 44a in the region in which the flexure 40 and the bride portion 54 overlap with each other, the maximum thickness ΔZmax of the base plate 42 region is the sum of the thickness of the base plate 42 and the thickness of the flexure 40. Namely, the maximum thickness ΔZmax does not include the thickness of the load beam 35, which means that the head suspension assembly 30 can be made thinner by the thickness of the load beam 35. As a result, a head suspension assembly with enhanced resistance against impact and wind disturbance can be obtained, with the strength of the proximal end of the load beam 35 maintained.

Also in the fourth embodiment, the island connections 38b and the extended connections 38a of the load beam 35 may be coupled using elongated coupling portions 38c with elasticity, as in the second embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Although in the above-described embodiments, independent plate-like arms are used as the arms of the head stack assembly, the invention is not limited to this. A structure comprising plural arms of an E-block shape and bearing sleeves integrated with the arms may be used. Magnetic disks are not limited to a size of 2.5 inches but may have any other size. The number of magnetic disks is not limited to two but may be one or three or more. The number of the head suspension assemblies may be increased or decreased in accordance with the number of magnetic disks mounted.

What is claimed is:

1. A head suspension assembly comprising:
a base plate including a first opening and a second opening;
a load beam including a proximal end secured onto the base plate and extending from the base plate;
a head supported on the load beam;
a flexure comprising a plurality of lines electrically connected to the head, and attached on the load beam and the base plate; and
a first piezoelectric element in the first opening of the base plate, and a second piezoelectric element in the second opening of the base plate,
wherein the proximal end of the load beam comprises first and second extended connections bifurcated from the proximal end and connected to the base plate, first and second island connections separate from each other and from the first and second extended connections and connected to the base plate, and an opening region exposing the base plate;
the first piezoelectric element comprises an end connected to the first extended connection, and another end connected to the first island connection;
the second piezoelectric element comprises an end connected to the second extended connection, and another end connected to the second island connection; and
the flexure extends, in the proximal end of the load beam, between the first and second extended connections and between the first and second island connections, and directly provided on the base plate.

2. The head suspension assembly of claim 1, wherein the proximal end of the load beam further comprises a bridge portion extending through the opening region and connecting the first and second island connections; and
the flexure comprises a metal thin plate, a first insulating layer, a conductive layer forming wiring, and a second insulating layer, which are layered on the metal thin plate in an order mentioned, a portion of the metal thin plate located in the opening region of the load beam and overlapping with the bridge portion being cut off to form a receiver slit receiving the bridge portion.

3. The head suspension assembly of claim 2, wherein the bridge portion is formed thinner than other portions of the load beam.

4. The head suspension assembly of claim 3, wherein the bridge portion have a thickness substantially equal to a thickness of the metal thin plate of the flexure.

5. The head suspension assembly of claim 4, wherein the first extended connection is connected to the first island connection by a first coupling portion, and the second extended connection is connected to the second island connection by a second coupling portion.

6. The head suspension assembly of claim 1, wherein the first extended connection is connected to the first island connection by a first coupling portion, and the second extended connection is connected to the second island connection by a second coupling portion.

7. The head suspension assembly of claim 2, wherein the first extended connection is connected to the first island connection by a first coupling portion, and the second extended connection is connected to the second island connection by a second coupling portion.

8. The head suspension assembly of claim 3, wherein the first extended connection is connected to the first island connection by a first coupling portion, and the second extended connection is connected to the second island connection by a second coupling portion.

9. A disk device comprising:
a disk-shaped recording medium;
a drive motor configured to support and rotate the recording medium;
a head configured to perform information processing on the recording medium; and
the head suspension assembly according to claim 1 and configured to support the head to be movable relative to the recording medium.

10. The disk device of claim 9, wherein the proximal end of the load beam further comprises a bridge portion extending through the opening region and connecting the first and second island connections; and
the flexure comprises a metal thin plate, a first insulating layer, a conductive layer forming wiring, and a second insulating layer, which are layered on the metal thin plate in an order mentioned, a portion of the metal thin plate located in the opening region of the load beam and overlapping with the bridge portion being cut off to form a receiver slit receiving the bridge portion.

11. The disk device of claim 10, wherein the bridge portion is formed thinner than other portions of the load beam.

12. The disk device of claim 11, wherein the bridge portion have a thickness substantially equal to a thickness of the metal thin plate of the flexure.

13. The disk device of claim 12, wherein the first extended connection is connected to the first island connection by a first coupling portion, and the second extended connection is connected to the second island connection by a second coupling portion.

14. The disk device of claim 9, wherein the first extended connection is connected to the first island connection by a first coupling portion, and the second extended connection is connected to the second island connection by a second coupling portion.

15. The disk device of claim 10, wherein the first extended connection is connected to the first island connection by a first coupling portion, and the second extended connection is connected to the second island connection by a second coupling portion.

16. The disk device of claim 11, wherein the first extended connection is connected to the first island connection by a first coupling portion, and the second extended connection is connected to the second island connection by a second coupling portion.
